(19) United States
(12) Patent Application Publication
(10) Pub. No.: US 2024/0296410 A1
(43) Pub. Date: Sep. 5, 2024

(54) Boosting user productivity of productivity platforms by leveraging gamification

(71) Applicant: Daniel Genkin, St. Catharines (CA)

(72) Inventor: Daniel Genkin, St. Catharines (CA)

(21) Appl. No.: 18/178,498

(22) Filed: Mar. 4, 2023

(51) Int. Cl. G06Q 10/0639; G06F 3/04815; G06T 17/00

(52) U.S. Cl. CPC G06Q 10/0639; G06F 3/04815; G06T 17/00

(57) ABSTRACT

This patent describes a productivity software solution that boosts user engagement and motivation by associating the value of tasks/jobs assigned to users with rewards. Users of the solution can complete tasks to earn points, then redeem the points for physical (e.g., merchandise) or virtual rewards. Virtual rewards can be used to customize components of user profiles (e.g., mascots or profile images) to allow the user to personalize their experience. Simultaneously, the productivity software solution keeps track of the completed tasks and assigns users a level/rank which they can use to compete against other users on leaderboards. Overall, this results in a gamified experience for the software users that provides instant rewards and boosts motivation for task completion, increases engagement of users with their tasks/jobs and yields a more enjoyable and productive experience.

### BACKGROUND OF THE INVENTION

Contemporary organizations strive to achieve maximal output to optimize profits, impact on society, or other objectives. For organizations to achieve these goals, their workers (employees, students, volunteers, etc.) need to be sufficiently motivated to complete their tasks well and in a timely manner. Organizations have several traditional methods for boosting this motivation. These methods include incentive programs, company events, Employee-of-the-year programs, etc. However, most of these methods are offered on an irregular or insufficiently frequent basis to present a consistent motivator for workers. Moreover, some of these fit-all methods may negatively impact worker performance as they may not be applicable or of interest to all workers.

In light of recent trends of Quiet-Quitting, working two jobs, and generally underperforming workers, organizations are finding that their traditional methods are failing to maintain worker motivation. Therefore, organizational efficiency is being negatively impacted. Clearly, there is a need for consistent motivators that can be personalized to every individual worker and will provide immediate feedback as workers do their work.

### SUMMARY OF THE INVENTION

This invention boosts user engagement with productivity platforms by associating each project, process and/or task (defined in this document as an activity that contributes to the successful completion of a project) with a certain number of points. Then, as subtasks that contribute to the overarching project or task are completed, the corresponding number of points are granted to the user who completed the task.

As users accumulate points, they can redeem them in exchange for rewards. These rewards can be physical (such as monetary compensation, some branded merchandise, etc.) and/or virtual (such as a decoration to the user's profile). A potential virtual benefit is a decorative hat that can be added to the user's profile image, avatar, mascot, and/or other graphic that is associated with the user or that the user interacts with. Another virtual benefit could be a banner with some positively-reenforcing text (e.g., ‘Top Performer’) that is added to their entry in an organizational chart. Overall, the goal is to allow users to personalize their public profile with decorations that they earn as they complete tasks.

After accumulating enough points, users will increase their level. Some embodiments may display user levels on organizational charts, leaderboards, or other user listings. Thus, levels act as a form of recognition for users' work. Levels reflect the total summation of points that users have accumulated and act as a milestone that workers strive to attain. Once a user attains a milestone, they will have an opportunity to play a game of chance (such as a lottery or spinner) to obtain a reward. These rewards can be physical or virtual (similar to the rewards granted by redeeming points) with more desirable rewards having a smaller chance of being obtained.

To provide motivation while users are working on a task, they may have an option to select to have a mascot cheer them on with motivational quotes and statements as well as with animations, sounds and appearances throughout the user interface of some embodiments. Some embodiments may allow users to personalize their mascots. In this case, some of the virtual rewards that users earn for their work can be decorations, costumes, and other accessories for the mascot. For example, after increasing their level, a user may enter a lottery to win a hat for their mascot.

If organizations wish to stimulate competition between users or teams of users, they can facilitate galleries where users can display their mascot or profile designs and vote for their favorite ones. Organizations can also organize leaderboards where the top performing users can receive recognition for their work as well as check their standings/rankings against their teammates and other users or against other teams, depending on the organization's configuration, which they can set to match their goals and culture. The configuration that organizations use defines the components of the invention that they implement in their embodiment for their users.

### BRIEF DESCRIPTION OF DRAWINGS

FIG. 1 Illustrates a sample embodiment of the invention in the form of an employee project management system. This screenshot shows a team of employees and a set of tasks for each employee. Mascot 104 shows sample mascot implementation.

FIG. 2 Illustrates a sample embodiment of a mascot customization screen. Users can customize their mascot with accessories that they have unlocked from completing tasks.

FIG. 3 Illustrates a sample mascot gallery where users can show off their mascots and vote for their favorite ones.

FIG. 4 Illustrates a sample embodiment of an organizational leaderboard where

organization members can compare their scores to their peers or can compare their team's score with other teams. The metrics displayed are defined by the embodiment.

FIG. 5 Illustrates a sample embodiment of a game of chance that can be played by users when they level up to randomly win some gift. This figure also shows how a mascot can be used to guide users.

FIG. 6 Illustrates a sample embodiment of a student project management system. This is similar to the one described in FIG. 1 but adapted for the student use case, where there is no team or manager.

FIG. 7 Illustrates a minimal sample interaction between a sample frontend and a sample backend implementation.

### DETAILED DESCRIPTION OF THE INVENTION

The following description presents one sample implementation/embodiment of the invention for employees in a company. Other sample embodiments, such as an embodiment for the student in education use case, will be discussed in the next subsection of this description. All sample embodiments discussed in this description are not intended to limit the present disclosure nor to limit its uses. As each organization has different objectives and a different culture, the invention is designed to have several extensibility and customization points to be flexible and to allow organizations to customize their selected embodiment to best fit their objectives. These extensibility points allow the invention to apply to many productivity platforms and thereby improve user motivation and productivity. These extensibility points include, but are not limited to, the points system, the mascot, and the leaderboard. They will be discussed in more detail throughout the detailed description. Moreover, some embodiments will not need to implement all features mentioned in this description whereas some others might implement more. Each customization (such as optional features, settings, preferences, options, etc.) discussed throughout the description shall be considered as being a feature in zero or more potential alternative embodiments where every permutation and every combination of potential configurations/customizations is applicable to one or more embodiments. This set of potential embodiments includes those that do not let the users, organizations, or other parties customize the customization value of the embodiment. For example, if there are two options for a customization, there will be three distinct embodiments of the invention that implement the customization (a customizable one, one with the first option, one with the second option) and one embodiment that does not implement the customization.

### Sample Embodiment for the Worker/Employee Use Case

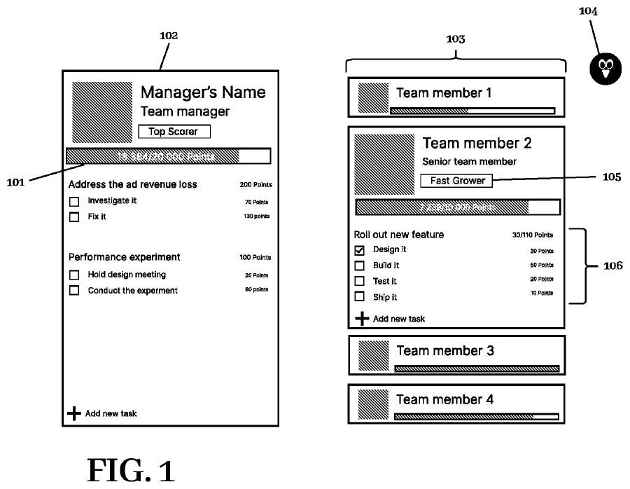

One possible embodiment of the invention takes the form of a project management software. This software allows members/workers/employees of an organization (the users of the software) to create and manage subtasks of their project within their team. For example, FIG. 1 shows a team of workers consisting of a manager (102) and five team members (103). Each worker in FIG. 1 has their own set of tasks that they are assigned to do. Task 106 shows an example task called ‘Roll out a new feature’ that is assigned to the worker named ‘Team Member 2’. Members of this team can exchange tasks and collaborate on them as project priorities shift or unexpected circumstances arise during development of the project.

Each task may or may not have subtasks. A subtask is a smaller task that contributes to the completion of a larger task. For example, in FIG. 1, task 106 has several subtasks. One of which is called ‘Design it’. In this embodiment, as subtasks are completed, they are marked with a checkmark, as is seen with the ‘Design it’ subtask.

All tasks and subtasks are assigned a certain value represented by a number of points. Once a task or subtask is completed, the corresponding number of points is granted to the worker who completed the task. Once all the subtasks of a task are completed, then the task is marked as completed.

The number of points that a task is worth depends on the value of the task to the overall project. A large and/or particularly important task should be worth more than a small and/or unimportant one. Workers will be more motivated to complete tasks with higher point values, as this will lead to faster level increases and more points to use for competition (discussed later). Therefore, it is important to ensure that the points adequately reflect the value of tasks to maintain fairness.

There are several methods of calculating the values of tasks. Organizations can choose which option would work best for their configuration/embodiment based on their needs. One option is to let workers decide by allowing them to input a positive integer value when they create or modify a task. This method is the most flexible but requires the most trust that workers will not abuse the system to gain points quickly. Another option is to use a set of predefined options that an automated system can then use to decide the final point value. For example, a worker may select a task's size as ‘medium’ and difficulty as ‘hard’. This would result in the system deciding that the task is worth a relatively large number of points. The categories, values, and formulae that are used to calculate the point value will vary by the embodiment. It is also possible to create more advanced options that use an artificial intelligence or some other data processing technique to value tasks based on a description, number of subtasks, importance, etc.

Depending on organizational configuration, workers who are supervisors/managers (or are responsible for a team of other workers) have an option to obtain points from completing their own tasks as well as when their team members complete tasks. This can be used to increase the motivation of supervisors/managers to keep their team members motivated as it has a direct influence on their points as well.

Tasks can be created by any worker and assigned to any one of their team members. For example, a manager can create a new task and assign it to themselves or any member of their team. This creation and delegation of tasks allows workers to offload tasks if they have too much workload, or add tasks if they have too little. Having too many tasks can result in workers feeling overwhelmed, which can result in decreased motivation as they feel that they cannot do everything. Once a task is created, the assigned worker can re-assign it to their co-workers if priorities shift, or it is decided that someone else is a better candidate to complete the task.

In the embodiment described in FIG. 1, each worker has a profile section with a progress bar (101) and a tag (105). Progress bars show a summation of all points that the corresponding worker has been granted and the number of points that are required for them to reach the next level/rank. Tags show the current level/rank of a worker or their standing on a leaderboard (discussed later).

FIG. 1 displays the progress bars (101) and tags (105) positioned in very visible locations and visible to all team members. This allows workers to see how their team members are progressing and it helps them compare their own progress to that of their co-workers. Thereby increasing competition between team members and acting as a motivator to boost task completion. Simultaneously, these indicators can help managers to justify decisions involving worker performance by acting as sources to quantify worker productivity and progress. Some embodiments may only permit workers to see their own progress bars and/or tags and some embodiments may position them in a different location, depending on the objectives of the organization.

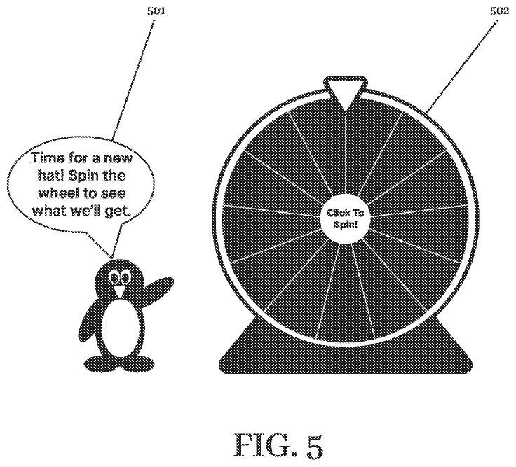

When a worker attains the number of points required to reach the next level/rank, their progress bar (101) and tag (105) is updated to show updated values. The worker also gets an opportunity to enter a random draw/lottery, or other game of chance, to win a new costume or decoration for their mascot, avatar, profile picture, or other graphic that is associated with the worker (discussed later). This is represented in FIG. 5, where 502 shows a spinner that randomly grants the worker a new costume or decoration. In this same figure, 501 shows a sample mascot dancing and pointing to a spinner to encourage the worker to spin it.

A mascot, avatar or other graphic (henceforth referred to as a simply a ‘mascot’) can be used throughout the project management software to motivate and encourage workers to complete tasks. Mascots in the context of this invention refer to a virtual character, or other graphic, that encourages workers and helps provide a more personal connection with the system. Mascots can take the form of some virtual character (such as a brand mascot) that the organization selects, a character or object model that the user uploads, or a pre-made generic character or virtual object (such as the one presented in the drawings).

Mascots encourage workers by animation/movement or by presenting inspirational communication in the form of messages, quotes, or jokes (such as the one shown in bubble 501 of FIG. 5). This communication can be either in textual form (such as via an on-screen pop-up speech bubble) or in auditory form (such as playing a voice recording through workers' device's speakers). This encouragement may be present throughout the entire project management platform, but especially after a worker achieves a goal. For example, a mascot can appear and give a worker a thumbs-up and a wink after they complete a task.

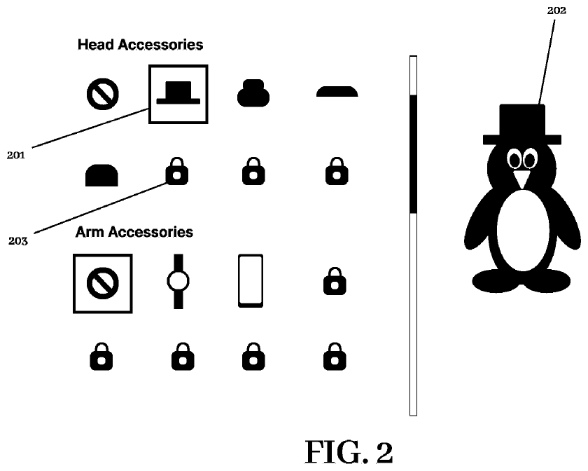

Mascots may be customizable and allow workers to personalize their individual mascot to express their individuality. Workers customize their mascot by redeeming points for costumes and/or decorations as well as by winning costumes and/or decorations from the game of chance that may be played upon workers attaining the next level. A sample implementation of this is illustrated in FIG. 2. In this mockup screenshot, preview 202 displays a live preview of the mascot that updates to reflect changes as workers make selections in the lists of available accessories to the left of the mascot preview. Item 201 shows an example hat accessory that workers can add to their mascot.

As workers obtain new accessories, they have a larger variety of accessories to use for customizing their mascot. Therefore, this helps drive motivation to complete tasks, gain points and thus obtain more accessories. Item 203 shows an accessory that the worker who is using the system has not yet obtained.

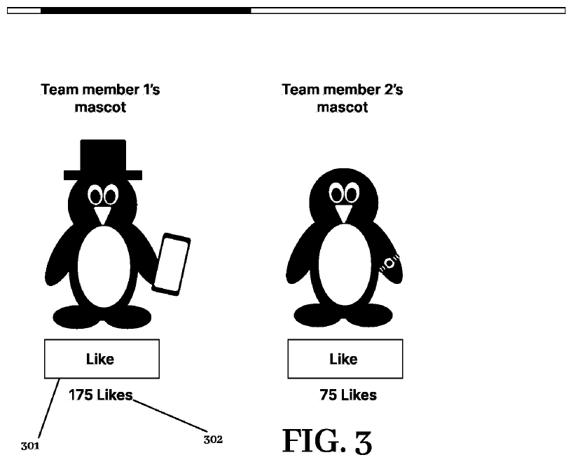

Upon finishing customization of their mascot, workers may present their mascot to their teammates, as well as to members in other teams, by listing their mascot on a mascot gallery, illustrated in FIG. 3. On this screen, other workers can vote for their favorite mascots (via button 301) and see which mascots are most liked by others (‘like’ counter 302). The worker who created the most liked mascot can then be awarded extra points, accessories, or some other rewards that the organization decides.

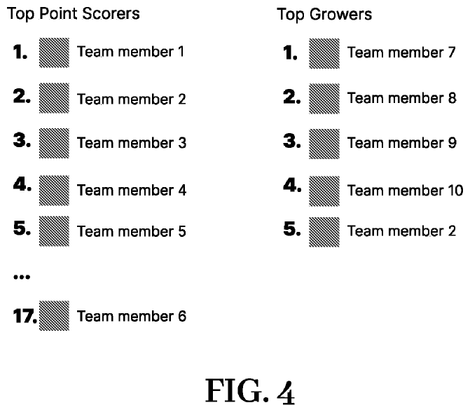

Similar to the mascot gallery, workers can also compete in leaderboards individually against their teammates, or in their teams against other teams (depending on the embodiment). A sample implementation of a leaderboard is shown in FIG. 4. The leaderboards that are presented to workers can be configured by the organization based on their objectives. Each leaderboard ranks workers of the same organizational level, or teams on the same organizational level, based on some metric. For example, FIG. 4 shows two leaderboards, ‘Top Points Scorers’ and ‘Top Growers’. Regardless of the metrics that each leaderboard shows, it is used by the embodiment to allow workers to compare their performance to that of their peers (teammates or other teams). Thus, this transparency in performance and sense of competition, can lead to workers having increased motivation to perform better.

The entire productivity platform, as in this example, may be designed with bright colors, rounded corners, and a minimalistic design. This technique can be used to create a light and engaging atmosphere in which the mascot and other motivational techniques are more effective and better integrated with the project management components. However, some embodiments (such as ones that do not have a discrete graphical interface as is discussed later) may forgo this design depending on the organizational objectives and/or to best suit the demographic that is using the embodiment.

### Sample Embodiment for the Learning and Student Education Use Case

The previous example explained a sample implementation for some types of workers (such as employees or volunteers) in an organization. With minor modification to the embodiments, the same invention can be used to create a project management platform that motivates many other types of workers. This section describes some potential embodiments for education, and specifically for students.

The points, mascots, mascot galleries, and leaderboards can all be used in the education system, in schools and classes by students. These interactive features can complement or replace traditional evaluation systems (such as percentage or letter grades) with virtual rewards and/or a sense of competition to provide a fun enjoyable and motivating experience for students.

For K-12 students to use an embodiment of the invention, students can be placed into ‘classes’ rather than ‘teams’, and students can be supervised and lead by ‘teachers’ rather than ‘managers’. Afterwards, K-12 students can use the same system as employees/workers from the previous example. Although, it would be advisable for embodiments used by schools to alter some additional features such as only allowing teachers to create, assign, delete, and modify tasks to avoid students from abusing the system.

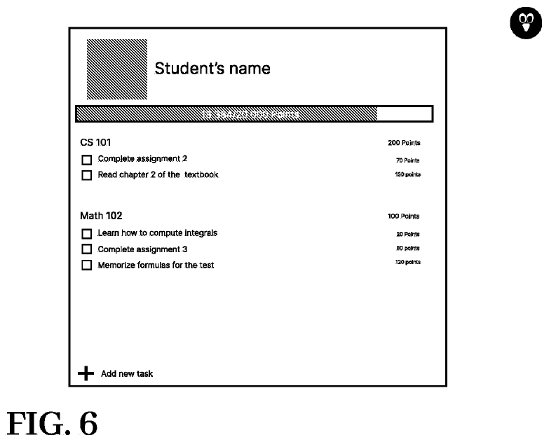

Students in post-secondary education can also use the system. However, since they do not have ‘teams’ or ‘managers’ and most K-12 student have unique sets of courses, post-secondary organizations can setup their platforms for students by assigning each student to their own ‘team’ where they are their own ‘manager’ (FIG. 6). In this case, the number of points that a task is worth may be assigned from the impact of the task to the student's final grade for a course. An embodiment that fulfills these changes will apply to post-secondary students to help them manage their tasks and receive access to the same motivational techniques as is explained for the previous example concerning employees.

### Some Additional Potential Embodiments

This invention could take the form of an application programming interface (API) that other software can use to integrate some, or all, of the features discussed in the previous sections (such as the mascots, leaderboards, points, etc.). For example, the API can be used to integrate with productivity tools (such as calendars, word processors, email clients, various internal tools) to automatically grant users points as they do their work.

Another possible embodiment could incorporate the invention and its benefits in a metaverse, or other platform or software in which users conduct work. For example, the invention could take the form of a virtual video conferencing room. In this embodiment, the user is immersed in the software, and they obtain points as they use the platform for work. For example, users can obtain points for organizing an event or meeting. The mascots, leaderboards and other features from the previous examples could also be adapted to this use case to obtain a similar motivation-increasing effect.

The embodiments of this invention may operate on any computer-based device. For example, some embodiments may take the form of productivity applications on smart glasses or other wearable devices. In this case, users could have a convenient way to quickly access the software and to obtain points as they do their work. Such embodiments could provide a very minimalistic user interface that just allows users to quickly access the system and indicate their progress on their task. For example, this could take the form of the user clicking a button on a smartwatch to indicate that the current task has been completed and the system should grant the user the corresponding points for it.

### Sample Backend/Server Implementation

The previous sections of this description described the user-facing components, which we will henceforth call the ‘frontend’. For some of the features of the frontend to be useful, a separate system needs to be used to store data for the users (such as the points, tasks, mascots, etc.). This separate system, which we will refer to as the ‘backend’, can be implemented in several different ways, neither of which is relevant to the scope of the disclosed invention. Therefore, as the patent's primary focus is on the frontend, this section will be dedicated to describing a very minimal implementation of a backend primarily for completeness. The backend described below is not intended to limit the scope of the invention but instead acts merely as a sample backend for implementors of the invention to consider.

The primary function of the backend will be to store data that is required for the proper operation of the frontend. This data may include the points, tasks, mascots, etc. Each user may have an account that associates their data with their login credentials. This ensures that only authorized users can access their data.

The frontend will send requests/messages to the backend that either request, add, delete, or modify data stored on the backend. These messages can be transmitted over the internet, over local networks, or over any other method for communicating between or within software applications that may or may not be on the same computer. The backend will then take the appropriate action based on the information provided in the request that was sent from the frontend. This action may involve sending back some data, creating new data, modifying existing data or some other operation on the data.

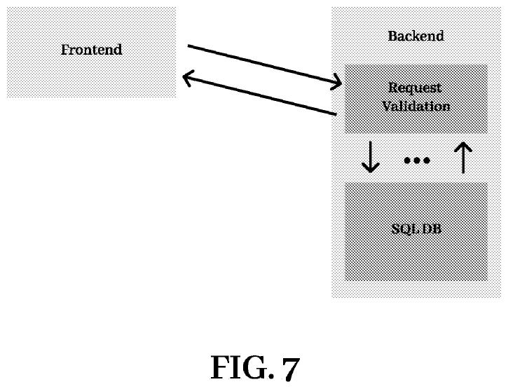

A possible embodiment of the backend (FIG. 7) can take the form of a relational database (such as SQL) that is running on an internet-accessible server which stores the data and can then provide the necessary functionality to operate upon it. There may or may not also be some additional software that validates requests prior to modifying data in the database to ensure that they are valid by checking properties such as formatting, authorization, etc.

There may also be additional layers of complexity that are part of the backend, such as proxy servers, caches, and other software and/or hardware components. However, as the intention of this description is to provide a minimal implementation of a potential backend, these details are omitted for brevity.

### Concluding Remarks

Technology serves as a method for improving the effectiveness and productivity of

humans. As technology continues to develop and become increasingly powerful, immersive, and productive, it is imperative that it is used effectively and efficiently. This invention aims to further improve the effective and efficient use of productivity platforms by making them more personalized, competitive, and/or fun for the users.

The goals and purposes of the described invention are achieved by leveraging gamification techniques and adapting them to the productivity use case. Specifically, this invention describes how organizations can use embodiments of the invention to leverage points, tasks, mascots, and/or a leaderboard to motivate users while using productivity platforms by making the platforms enjoyable to use. Thereby, driving task completion and increasing productivity from the organization's members.

1. A productivity tool, comprising:
a. a graphical user interface,
b. a plurality of predetermined actions that a user can perform via said graphical user interface,
c. a transactional reward system, and
d. a means for associating the value of completing an action from the said plurality of actions with a reward from said reward system
Whereby, the user who completes said action receives a reward from said reward system.

2. The productivity tool of claim 1 wherein the transaction reward system contains means for causing it to provide a random reward.

3. The productivity tool of claim 1 wherein the transaction reward system contains means for causing it to provide a reward that is chosen by the user.

4. The productivity tool of claim 1 wherein the means for associating the value of completing an action from the said plurality of actions with a reward from said reward system is a points system that grants the user who completed the action a predefined number of points that are associated with the action.

5. The productivity tool of claim 1 wherein a reward from said transactional reward system is a new costume, decoration or other accessory to a component of the user's profile, such as a mascot.

6. A productivity tool, comprising:
a. a graphical user interface,
b. a plurality of predetermined actions that a user can perform via said graphical user interface,
c. a reward system,
d. a system that ranks users,
e. a means for associating the values of the actions from the said plurality of actions that a user has completed with said system that ranks users, and
f. a means for granting a reward to users via said reward system once they attain the next rank of said system that ranks users
Whereby users increase their ranking as they complete actions and receive rewards when their rank increases.

7. The productivity tool of claim 6 wherein the system that ranks users uses a summation of the values of the actions that said users have completed when determining the ranks of said users.

8. The productivity tool of claim 6 wherein the system that ranks users applies a predefined formula to the values of the actions that said users have completed when determining the ranks of said users.

9. The productivity tool of claim 6 wherein the system that ranks users applies a predefined algorithm to the values of the actions that said users have completed when determining the ranks of said users.

10. A productivity tool, comprising:
a. a graphical user interface,
b. a virtual character, mascot, avatar, image, or object that appears through said graphical user interface to provide guidance, motivational messages, jokes, quotations, or other messages to the user, and
c. a means for users to customize said character or object.

11. The productivity tool of claim 10 wherein the graphical user interface is part of a website.

12. The productivity tool of claim 10 wherein the graphical user interface is part of an application.

13. The productivity tool of claim 10 wherein the graphical user interface is part of a metaverse or other immersive three-dimensional or two-dimensional virtual environment.

14. The productivity tool of claim 10 wherein the graphical user interface is displayed on a computer monitor.

15. The productivity tool of claim 10 wherein the graphical user interface is displayed on a wearable device.
